(19) United States
(12) Patent Application Publication
(10) Pub. No.: US 2024/0349218 A1
(43) Pub. Date: Oct. 17, 2024

(54) REGISTRATION TO A NETWORK SLICE SUBJECT TO ADMISSION CONTROL

(71) Applicant: Lenovo (Singapore) Pte. Ltd., New Tech Park (SG)

(72) Inventors: Roozbeh Atarius, La Jolla, CA (US); Genadi Velev, Darmstadt (DE)

(21) Appl. No.: 18/681,829

(22) PCT Filed: Aug. 5, 2022
(86) PCT No.: PCT/IB2022/057337

§ 371 Date: Feb. 6, 2024

Related U.S. Application Data
(60) Provisional application No. 63/230,599, filed on Aug. 6, 2021.

(51) Int. Cl. H04W 60/00; H04W 48/08; H04W 48/18

(52) U.S. Cl. CPC H04W 60/00; H04W 48/08; H04W 48/18

(57) ABSTRACT

Apparatuses, methods, and systems are disclosed for registering to a congested network slice. One method includes receiving a registration request from a communication device to register to a network slice subject to NSAC and determining that registration to the network slice is rejected for NSAC. The method includes initiating a timer in response to determining that the registration to the network slice is rejected and sending, to the communication device, an update message in response to expiry of the timer, the update message including an indication that the communication device is permitted to register to the network slice.

### CROSS-REFERENCE TO RELATED APPLICATIONS

This application claims priority to U.S. Provisional Patent Application No. 63/230,599 entitled “REGISTRATION TO A NETWORK SLICE SUBJECT TO ADMISSION CONTROL” and filed on 6 Aug. 2021 Roozbeh Atarius and Genadi Velev, which application is incorporated herein by reference.

### FIELD

The subject matter disclosed herein relates generally to wireless communications and more particularly relates to methods and apparatus for registration to a network slice subject to admission control.

### BACKGROUND

One of the new features introduced in the Third Generation Partnership Project (“3GPP”) Fifth Generation (“5G”) communication system is the support of network slicing. With the evolution of the 5G system (“5GS”) and the network slicing feature, the network slice admission control was introduced. A network slice identified by Single Network Slice Selection Assistance Information (“S-NSSAI”) can be a subject to Network Slice Admission Control (“NSAC”). The 5GS may include a Network Slice Admission Control Function (“NSACF”) that monitors and controls the number of registered User Equipment (“UE”) devices per network slice for those network slices that are subject to NSAC.

### BRIEF SUMMARY

Disclosed are procedures for registering to a congested network slice, i.e., a network slice subject to admission control. Said procedures may be implemented by apparatus, systems, methods, or computer program products.

One method at a network device includes receiving a registration request from a communication device to register to a network slice subject to NSAC and determining that registration to the network slice is rejected for NSAC. The first method includes initiating a timer in response to determining that the registration to the network slice is rejected and sending, to the communication device, an update message in response to expiry of the timer, the update message containing a first indication that the communication device is permitted to register to the network slice.

One method at a UE includes sending, by the communication device, a registration request to register to a network slice in a mobile communication network, the network slice subject to NSAC and receiving, from an access management function, a first response including an allowed set of network slices and a first indication that rejects registration to the network slice. The second method includes receiving, from the access management function, a second response including a second indication that the communication device is permitted to register to the network slice and establishing, by the communication device, a data connection using the network slice.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for registering to a congested network slice;

FIG. 2 is a diagram illustrating one embodiment of a New Radio (“NR”) protocol stack:

FIG. 3 is a diagram illustrating one embodiment of an Extended Rejected Network Slice Selection Assistance Information (“ER-NSSAI”) information element (“IE”):

FIG. 4 is a diagram illustrating one embodiment of a Partial ER-NSSAI list:

FIG. 5 is a diagram illustrating one embodiment of a 5G Mobility Management (“5GMM”) capability IE:

FIG. 6 is a signal flow diagram illustrating one embodiment of a procedure for registering to a congested network slice:

FIG. 7 is a block diagram illustrating one embodiment of a user equipment apparatus that may be used to register to a network slice:

FIG. 8 is a block diagram illustrating one embodiment of a network apparatus that may be used for registering to a congested network slice; and

FIG. 9 is a flowchart diagram illustrating another embodiment of a method for registering to a congested network slice; and

FIG. 10 is a flowchart diagram illustrating one embodiment of a second method for registering to a congested network slice.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising,” “having.” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

### [Overview+Problem Statement]

Generally, the present disclosure describes systems, methods, and apparatuses for registering to a congested network slice. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions. A network slice customer can negotiate (or request) slice characteristics (or attributes) from the network operator (e.g., 5GS) deploying the network slice. The network slice characteristics may be identified by network slice attributes. Possible network slice attributes are described in the Groupe Speciale Mobile Association (“GSMA”) 5G Joint Activity (“5GJA”) working group in the document GSMA 5GJA NG.116 “Generic Network Slice Template”. The network operator uses the Generic Network Slice Template (“GST”) to derive the network slice characteristics.

One attribute in the GST is Maximum number of data connections (e.g., Protocol Data Unit (“PDU”) sessions or Packet Data Network (“PDN”) connections or Evolved Packet System (“EPS”) sessions). This attribute describes the maximum number of concurrent data connections supported by the network slice. In some embodiments, this attribute may include an optional parameter “EPS counting required” to indicate that PDN connections (also referred to as EPS sessions) are to be tracked. In one example, a network slice subject to NSAC may be limited to 100,000 concurrent data connections. In another example, the network slice subject to NSAC may be limited to 10,000,000 concurrent data connections. Table 1 depicts an example of the GST attribute for a Maximum number of PDU sessions.

TABLE 1
Maximum Number of PDU Sessions
Parameters

| | |
|---|---|
| Measurement unit | kbps |
| Example | 100 000 concurrent PDU sessions |
| | 10 000 000 concurrent PDU sessions |
| Allowed Values | Any desired value |
| Tags | Scalability attribute |

Attribute Presence

| | |
|---|---|
| Mandatory | |
| Conditional | |
| Optional | X |

Another attribute in the GST is Maximum number of communication devices (e.g., UEs). This attribute describes the maximum number of devices that can use the network slice simultaneously. In some embodiments, this attribute may include an optional parameter “EPS counting required” to indicate that UEs using PDN connections (also referred to as EPS sessions) that can be handed over to the 5GS (while the UEs are in the EPS) are to be tracked. In one example, a network slice subject to NSAC may be limited to 100,000 concurrent devices/users. In another example, the network slice subject to NSAC may be limited to 10,000,000 concurrent devices/users. Table 2 depicts an example of the GST attribute for a Maximum number of UEs.

TABLE 2
Maximum number of UEs
Parameters

| | |
|---|---|
| Measurement unit | NA |
| Allowed Values | Any desired value |
| Example | 100 000 concurrent UEs |
| | 10 000 000 concurrent UEs |
| Tags | Scalability attribute |

Attribute Presence

| | |
|---|---|
| Mandatory | |
| Conditional | |
| Optional | X |

As described above, the 5G network slicing feature enables network operators to optimize implementation of tailor-made functionality and network operation specific to the needs of a market scenario. The network slicing feature can be summarized as follows:

A network slice is a logical network that provides specific network capabilities and network characteristics. The network slice is identified by an S-NSSAI and may consist of a radio access network (“RAN”) part and a core network (“CN”) part. While the network can support large number of slices (e.g., hundreds), the UE need not support more than eight (8) slices simultaneously. Traffic for different slices is handled by different PDU sessions.

An S-NSSAI uniquely identifies a network slice and is comprised of a Slice/Service type (“SST”) and a Slice Differentiator (“SD”). The SST refers to the expected network slice behavior in terms of features and services. The SST field is of length 8 bits and may have standardized and non-standardized values: values 0 to 127 belong to the standardized SST range and are defined in 3GPP Technical Specification (“TS”) 23.501, and values 128 to 255 belong to the Operator-specific range.

The SD is optional information that complements the SST(s) to differentiate amongst multiple network slices of the same SST. For instance, for an SST of value eMBB, multiple SDs may be defined such as “Company X eMBB slice,” “Company Y eMBB slice” etc. The SD field is of length 24 bits. Optionally, the S-NSSAI may also include a mapped home Public Land Mobile Network (“HPLMN”) SST and/or mapped HPLMN SD.

The UE subscription data in the UDM/UDR stores a list of one or more Subscribed S-NSSAI(s), which a UE is subscribed to use in a Public Land Mobile Network (“PLMN”) (e.g., in a HPLMN or visited PLMN (“VPLMN”)).

A UE may be configured by the network with the following network slice configuration: Allowed Network Slice Selection Assistance Information (“NSSAI”) and Configured NSSAI. The Allowed NSSAI is a list of one or more S-NSSAIs provided by the serving PLMN during e.g. a Registration procedure, indicating the S-NSSAIs values the UE could use in the serving PLMN for the current Registration Area: derived by network from the Subscribed S-NSSAI and taking into account the S-NSSAIs which are valid for the current registration area and Access Type provided by the Access and Mobility Management Function (“AMF”) the UE has registered with: used by UE, e.g., to create IE “Requested NSSAI” in the Non-Access Stratum (“NAS”) registration request message and to establish PDU Sessions in the current registration area.

The configured NSSAI is a list of one or more S-NSSAIs applicable to one or more PLMNs and is derived by network from the Subscribed S-NSSAI. The configured NSSAI is used by UE if there are no allowed S-NSSAI(s) for the current PLMN (or Standalone Non-Public Network (“SNPN”)). The configured NSSAI contains only S-NSSAI values from the serving PLMN (i.e., which can be the HPLMN or a VPLMN). The configured NSSAI is obtained from the AMF upon successful completion of a UE's Registration procedure over an Access Type or as part of UE network slice configuration update procedure and is used by UE, e.g., to create the IE “Requested NSSAI” in the NAS registration request message. Note that the Requested NSSAI IE comprises a list of one or more S-NSSAIs to which the UE requests registration.

A network slice identified by S-NSSAI can be a subject to NSAC. The NSAC allows the use of the S-NSSAI resources up to a maximum number of registered UEs and/or a maximum number of established PDU Sessions in the S-NSSAI. If the maximum number of registered UEs and/or established PDU Sessions in the S-NSSAI are reached, then new UEs or PDU Sessions are rejected.

The NSACF monitors and controls the number of registered UEs per network slice for the network slices that are subject to NSAC. The NSACF and AMF are configured via the Operations, Administration and Maintenance (“OAM”) system that an S-NSSAI is subject to NSAC. The NSACF is configured with the maximum number of registered UEs and/or established PDU Sessions which are allowed to be served by the S-NSSAI that is subject to NSAC.

The NSACF controls (i.e., increase or decrease) the current number of UEs registered with a network slice so that the current number of UEs does not exceed the maximum number of UEs allowed to register with that network slice. The NSACF also maintains a list of one or more UE IDs registered with a network slice that is subject to NSAC. When the current number of UEs registered with a network slice is to be increased (i.e., when a UE attempts to register with the network slice), the NSACF first checks whether the UE Identity is already in the list of UEs registered with that network slice and if not, it checks whether the maximum number of UEs per network slice for that network slice has already been reached.

The AMF sends a request to NSACF when the UE registers with or deregisters from the S-NSSAI subject to NSAC, i.e., during the UE Registration procedure in clause 4.2.2.2.2 in 3GPP TS 23.502, UE Deregistration procedure in clause 4.2.2.3 in 3GPP TS 23.502, or UE Configuration Update procedure in clause 4.2.4.2 in 3GPP TS 23.502.

There can be a situation when a UE attempts to register with several S-NSSAIs however one or more S-NSSAIs may be subject to NSAC, and thus, congested due to the number of registered UEs exceeding the maximum number of UEs. As used herein, a “congested network slice” refers to any network slice (i.e., identified by S-NSSAI) subject to NSAC, where a limit (i.e., maximum number) is reached for a monitored network slice attribute/characteristic, such that access to the network slice is restricted. While the below descriptions discuss network slice congestion primarily in terms of the attribute “maximum number of UEs per network slice”, this is an exemplary attribute and the below solutions also apply to other monitored network slice attributes/characteristics where access restrictions are implemented once the monitored attribute/characteristics reaches a configured maximum value. The monitored network slice attribute of a network slice subject to NSAC may also be referred to as a “NSAC attribute” or “NSAC parameter.” Release 17 of 3GPP TS 24.501 has specified a mechanism where the network will inform the UE that those one or more S-NSSAIs are rejected and optionally also including a timer. The UE attempts to access to the one or more congested S-NSSAIs after the timer is expired by registration or without registration.

In order for the network to realize whether the UE support this mechanism, a new 5GMM capability IE which is called ER-NSSAI is defined. The UE uses this 5GMM capability IE to indicate to the network whether the UE supports the ER-NSSAI which includes a back off timer for the S-NSSAI which rejected for the maximum number of UEs reached. Once the back-off timer is expired the UE may attempt to register with the currently congested one or more S-NSSAIs.

The problem is that it is unclear whether and how the network (e.g., the AMF) rejects the S-NSSAI subject to NSAC towards UEs which does not support the NSAC feature (e.g., the ER-NSSAI). If the UE does not support the ER-NSSAI, such as that the UE has not implemented it or the UE is a pre-release 17 UE, then the network may need to communicate with the UE if the UE has attempted to register with one or more S-NSSAIs but failed due to congestion (i.e., exhaustion) for those one or more S-NSSAIs. Moreover, it is not clear how the network estimates the back-off timer to indicate to the UE when the one or more congested S-NSSAIs will be accessible.

Disclosed are solutions that a network may use to indicate to a UE with no capability for extended rejected S-NSSAI to attempt registering to the one or more S-NSSAIs which the UE was denied for due to the congestion. The solutions may be implemented by apparatus, systems, methods, or computer program products.

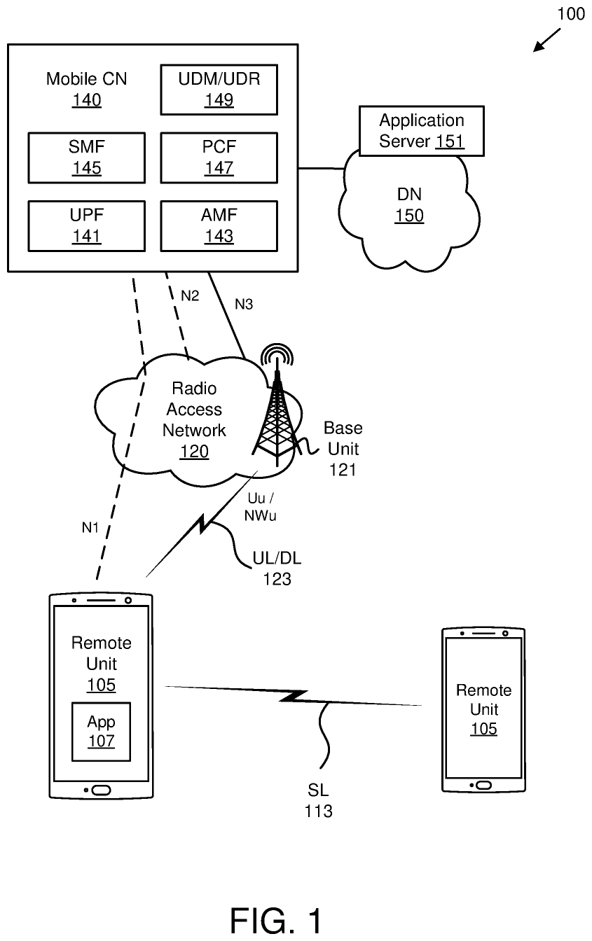

### [FIG. 1—Overall System]

FIG. 1 depicts a wireless communication system 100 for registering to a congested network slice, according to embodiments of the disclosure. In one embodiment, the wireless communication system 100 includes at least one remote unit 105, a RAN 120, and a mobile CN 140. The RAN 120 and the mobile CN 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile CNs 140 are depicted in FIG. 1, one of skill in the art will recognize that any number of remote units 105, base units 121, wireless communication links 123, RANs 120, and mobile CNs 140 may be included in the wireless communication system 100.

In one implementation, the RAN 120 is compliant with the 5G cellular system specified in the 3GPP specifications. For example, the RAN 120 may be a Next Generation Radio Access Network (“NG-RAN”), implementing NR Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Furthermore, the UL communication signals may comprise one or more UL channels, such as the Physical Uplink Control Channel (“PUCCH”) and/or Physical Uplink Shared Channel (“PUSCH”), while the DL communication signals may comprise one or more DL channels, such as the Physical Downlink Control Channel (“PDCCH”) and/or Physical Downlink Shared Channel (“PDSCH”). Here, the RAN 120 is an intermediate network that provides the remote units 105 with access to the mobile CN 140.

In various embodiments, the remote units 105 may communicate directly with each other (e.g., device-to-device communication) using one or more sidelink communication links 113. Here, sidelink transmissions may occur on sidelink resources. A remote unit 105 may be provided with different sidelink communication resources according to different allocation modes. As used herein, a “resource pool” refers to a set of resources assigned for sidelink operation. A resource pool consists of a set of resource blocks (i.e., Physical Resource Blocks (“PRB”)) over one or more time units (e.g., subframe, slots, Orthogonal Frequency Division Multiplexing (“OFDM”) symbols). In some embodiments, the set of resource blocks comprises contiguous PRBs in the frequency domain. A PRB, as used herein, consists of twelve consecutive subcarriers in the frequency domain.

In some embodiments, the remote units 105 communicate with an application server 151 via a network connection with the mobile CN 140. For example, an application 107 (e.g., web browser, media client, telephone and/or Voice-over-Internet-Protocol (“VoIP”) application) in a remote unit 105 may trigger the remote unit 105 to establish a PDU session (or PDN connection) with the mobile CN 140 via the RAN 120. The PDU session represents a logical connection between the remote unit 105 and the User Plane Function (“UPF”) 141. The mobile CN 140 then relays traffic between the remote unit 105 and the application server 151 in the DN 150 using the PDU session (or other data connection).

In order to establish the PDU session (or PDN connection), the remote unit 105 must be registered with the mobile CN 140 (also referred to as “attached to the mobile core network” in the context of a Fourth Generation (“4G”) system). Note that the remote unit 105 may establish one or more PDU sessions (or other data connections) with the mobile CN 140. As such, the remote unit 105 may have at least one PDU session for communicating with the DN 150. The remote unit 105 may establish additional PDU sessions for communicating with other data networks and/or other communication peers.

In the context of a 5GS, the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5QI”).

In the context of a 4G/LTE system, such as the EPS, a PDN connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW”, not shown) in the mobile CN 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of the RAN are not illustrated but are well known generally by those having ordinary skill in the art. The base units 121 connect to the mobile CN 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121.

Note that during NR operation on unlicensed spectrum (referred to as “NR-U”), the base unit 121 and the remote unit 105 communicate over unlicensed (i.e., shared) radio spectrum. Similarly, during LTE operation on unlicensed spectrum (referred to as “LTE-U”), the base unit 121 and the remote unit 105 also communicate over unlicensed (i.e., shared) radio spectrum.

In one embodiment, the mobile CN 140 is a 5G Core network (“5GC”) or an Evolved Packet Core (“EPC”), which may be coupled to a DN 150, like the Internet and private data networks, among other data networks. A remote unit 105 may have a subscription or other account with the mobile CN 140. In various embodiments, each mobile CN 140 belongs to a single mobile network operator (“MNO”) and/or PLMN. The present disclosure is not intended to be limited to the implementation of any particular wireless communication system architecture or protocol.

The mobile CN 140 includes several network functions (“NFs”). As depicted, the mobile CN 140 includes at least one UPF 141. The mobile CN 140 also includes multiple control plane (“CP”) functions including, but not limited to, an AMF 143 that serves the RAN 120, a Session Management Function (“SMF”) 145, a Policy Control Function (“PCF”) 147, a Unified Data Management function (“UDM”) and a User Data Repository (“UDR”). In some embodiments, the UDM is co-located with the UDR, depicted as combined entity “UDM/UDR” 149. Although specific numbers and types of NFs are depicted in FIG. 1, one of skill in the art will recognize that any number and type of NFs may be included in the mobile CN 140.

The UPF(s) 141 is/are responsible for packet routing and forwarding, packet inspection, QoS handling, and external PDU session for interconnecting a DN, in the 5G architecture. The AMF 143 is responsible for termination of NAS signaling, NAS ciphering and integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation and management, DL data notification, and traffic steering configuration of the UPF 141 for proper traffic routing.

As described above, the NSACF 146 monitors and controls the number of registered remote units 105 per network slice for the network slices that are subject to NSAC. The PCF 147 is responsible for unified policy framework, providing policy rules to CP functions, access subscription information for policy decisions in UDR. The PCF 147 is responsible for unified policy framework, providing policy rules to CP functions, access subscription information for policy decisions in UDR.

The UDM is responsible for generation of Authentication and Key Agreement (“AKA”) credentials, user identification handling, access authorization, subscription management. The UDR is a repository of subscriber information and may be used to service a number of NFs. For example, the UDR may store subscription data, policy-related data, subscriber-related data that is permitted to be exposed to third party applications, and the like. As indicated above, the UDM and UDR may be co-located and/or combined into a single network function (“NF”).

In various embodiments, the mobile CN 140 may also include a Network Repository Function (“NRF”) (which provides NF service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile CN 140 may include an authentication, authorization, and accounting (“AAA”) server.

In various embodiments, the mobile CN 140 supports different types of mobile data connections and different types of network slices, wherein each mobile data connection utilizes a specific network slice. Here, a “network slice” refers to a portion of the mobile CN 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a S-NSSAI while a set of network slices for which the remote unit 105 is authorized to use is identified by NSSAI. Here, “NSSAI” refers to a vector value including one or more S-NSSAI values. In certain embodiments, the various network slices may include separate instances of NFs, such as the SMF 145 and UPF 141. In some embodiments, the different network slices may share some common NFs, such as the AMF 143. The different network slices are not shown in FIG. 1 for ease of illustration, but their support is assumed.

While FIG. 1 depicts components of a 5G RAN and a 5G core network (“5GC”), the described embodiments for registering to a congested network slice apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA2000, Bluetooth, ZigBee, Sigfox, and the like.

Moreover, in an LTE variant where the mobile CN 140 is an EPC, the depicted NFs may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a CP portion of a PGW and/or to an MME, the UPF 141 may be mapped to an SGW and a UP portion of the PGW, the UDM/UDR 149 may be mapped to an HSS, etc. Note that the MME is an access management function in the EPS and the AMF 143 is a corresponding access management function in the 5GS. As used herein, the term “access management function” is used to reference any network entity/function that interacts with the remote unit 105 to control access to a network slice or similar network resource.

In the following descriptions, the term “gNB” is used for the base station/base unit, but it is replaceable by any other radio access node, e.g., RAN node, ng-eNB, eNB, Base Station (“BS”), Access Point (“AP”), NR BS, 5G NB, Transmission and Reception Point (“TRP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for registering to a congested network slice.

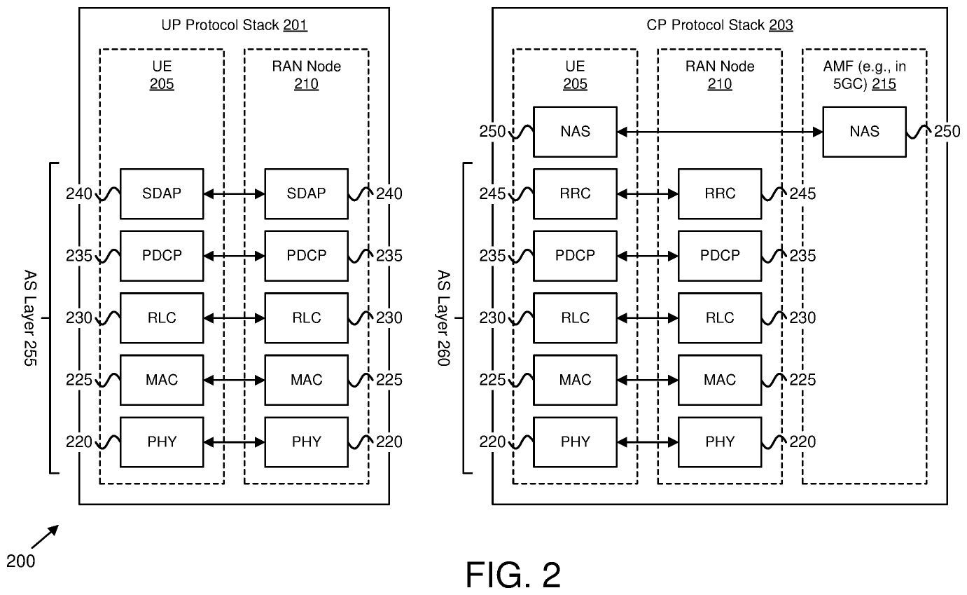

### [FIG. 2—NR Protocol Stack]

FIG. 2 depicts a NR protocol stack 200, according to embodiments of the disclosure. While FIG. 2 shows the UE 205, the RAN node 210 and an AMF 215 in a 5GC, these are representative of a set of remote units 105 interacting with a base unit 121 and a mobile CN 140. As depicted, the NR protocol stack 200 comprises a UP protocol stack 201 and a CP protocol stack 203. The UP protocol stack 201 includes a physical (“PHY”) layer 220, a Medium Access Control (“MAC”) sublayer 225, the Radio Link Control (“RLC”) sublayer 230, a Packet Data Convergence Protocol (“PDCP”) sublayer 235, and Service Data Adaptation Protocol (“SDAP”) layer 240. The CP protocol stack 203 includes a PHY layer 220, a MAC sublayer 225, a RLC sublayer 230, and a PDCP sublayer 235. The CP protocol stack 203 also includes a Radio Resource Control (“RRC”) layer 245 and a NAS layer 250.

The AS layer 255 (also referred to as “AS protocol stack”) for the UP protocol stack 201 consists of at least SDAP, PDCP, RLC and MAC sublayers, and the physical layer. The AS layer 260 for the CP protocol stack 203 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC layer 245 and the NAS layer 250 for the CP and includes, e.g., an IP layer and/or PDU Layer (not depicted) for the UP. L1 and L2 are referred to as “lower layers,” while L3 and above (e.g., transport layer, application layer) are referred to as “higher layers” or “upper layers.”

The PHY layer 220 offers transport channels to the MAC sublayer 225. The PHY layer 220 may perform a beam failure detection procedure using energy detection thresholds, as described herein. In certain embodiments, the PHY layer 220 may send an indication of beam failure to a MAC entity at the MAC sublayer 225. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the CN (e.g., 5GC). The RRC layer 245 provides for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and the AMF 215 in the 5GC. NAS messages are passed transparently through the RAN. The NAS layer 250 is used to manage the establishment of communication sessions and for maintaining continuous communications with the UE 205 as it moves between different cells of the RAN. In contrast, the AS layers 255 and 260 between the UE 205 and the RAN (i.e., RAN node 210) and carries information over the wireless portion of the network. While not depicted in FIG. 2, the IP layer exists above the NAS layer 250, a transport layer exists above the IP layer, and an application layer exists above the transport layer.

The MAC sublayer 225 is the lowest sublayer in the L2 architecture of the NR protocol stack. Its connection to the PHY layer 220 below is through transport channels, and the connection to the RLC sublayer 230 above is through logical channels. The MAC sublayer 225 therefore performs multiplexing and demultiplexing between logical channels and transport channels: the MAC sublayer 225 in the transmitting side constructs MAC PDUs, known as transport blocks, from MAC Service Data Units (“SDUs”) received through logical channels, and the MAC layer 225 in the receiving side recovers MAC SDUs from MAC PDUs received through transport channels.

The MAC sublayer 225 provides a data transfer service for the RLC layer 230 through logical channels, which are either control logical channels which carry control data (e.g., RRC signaling) or traffic logical channels which carry UP data. On the other hand, the data from the MAC sublayer 225 is exchanged with the PHY layer 220 through transport channels, which are classified as DL or UL. Data is multiplexed into transport channels depending on how it is transmitted over the air.

The PHY layer 220 is responsible for the actual transmission of data and control information via the air interface, i.e., the PHY Layer 220 carries all information from the MAC transport channels over the air interface on the transmission side. Some of the important functions performed by the PHY layer 220 include coding and modulation, link adaptation (e.g., Adaptive Modulation and Coding (“AMC”)), power control, cell search and random access (for initial synchronization and handover purposes) and other measurements (inside the 3GPP system (i.e., NR and/or LTE system) and between systems) for the RRC layer 245. The PHY layer 220 performs transmissions based on transmission parameters, such as the modulation scheme, the coding rate (i.e., the modulation and coding scheme (“MCS”)), the number of physical resource blocks, etc.

### [Solutions]

In case one or more S-NSSAIs are congested, a UE cannot register with them and at the time of registration. However, if the congestion is resolved (e.g., a current number of registered UEs per network slice of a requested S-NSSAI drops below the limit), there should be a mechanism to inform the UE, in case the UE is to attempt a new registration for the one or more S-NSSAIs. Accordingly, the ER-NSSAI IE is defined which groups one or more S-NSSAIs with an assigned back-off timer for indicating to the UE when the UE can retry to register with the one or more S-NSSAIs.

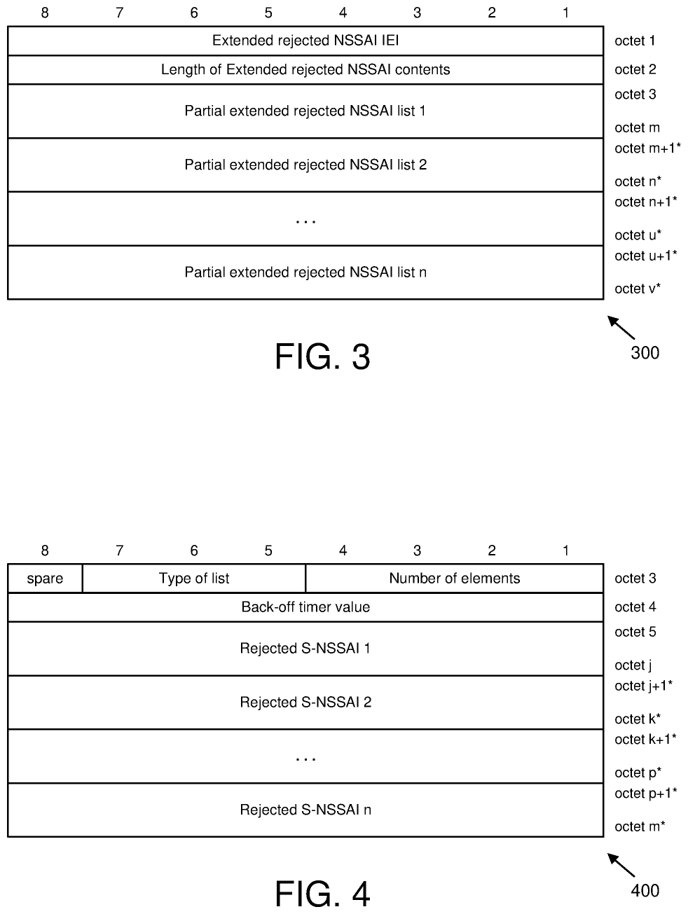

FIG. 3 shows one example of an ER-NSSAI IE 300, according to embodiments of the disclosure. As noted above, the ER-NSSAI IE 300 is used to identify a set of rejected S-NSSAI. In the ER-NSSAI IE 300, the first octet comprises an IE identifier (“IEI”) used to indicate that the ER-NSSAI IE 300 is an ER-NSSAI IE. The second octet comprises a length field indicating the length of the ER-NSSAI contents.

The value portion 305 of the ER-NSSAI IE 300 (i.e., composed of octets 3 to v) is composed of one or more partial extended rejected NSSAI lists, described in greater detail with reference to FIG. 4. In some embodiments, the number of rejected S-NSSAI in the ER-NSSAI IE 300 is limited to eight or less.

### [FIG. 4—Partial Extended Rejected NSSAI List]

FIG. 4 shows one example of a partial extended rejected NSSAI list 400, according to embodiments of the disclosure. Each partial extended rejected NSSAI list includes a back-off timer value and a list of up to eight S-NSSAI. Each rejected S-NSSAI includes an S-NSSAI (to identify a respective network slice) and a cause value. In various embodiments, one or more values of a 4-bit cause value field (not depicted in FIG. 4) may encode an indication that the network slice (e.g., identified by S-NSSAI) is rejected for NSAC reasons, for example, indicating that the S-NSSAI is not available due to a maximum number of UEs being reached.

The back-off timer value indicates how long the UE should wait before again attempting to register with a respective network slice (e.g., identified by S-NSSAI) that was rejected for NSAC reasons. However, as described above, a legacy UE that does not support ER-NSSAI (e.g., a model of UE from before implementation of the ER-NSSAI) would not be capable of interpreting the ER-NSSAI IE and implementing the back-off timer.

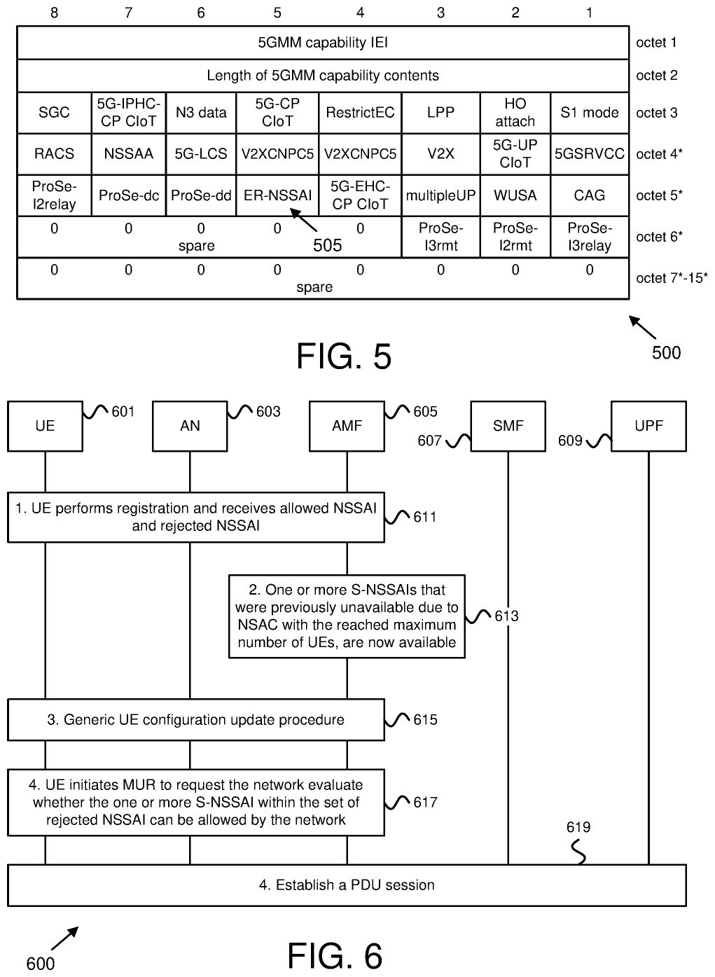

### [FIG. 5—5GMM Capability IE]

FIG. 5 shows one example of a 5GMM IE 500, according to embodiments of the disclosure Because the support of ER-NSSAI is optional for the UE, the UE needs to inform the network at the time of registration that the UE is capable of ER-NSSAI. This is done by a defined bit of the 5GMM capability IE, i.e., ER-NSSAI field 505. In some embodiments, the value of ER-NSSAI is set to “1” to indicate that the UE supports ER-NSSAI, but is set to “0” if the UE does not support the ER-NSSAI. Note that a pre-release 16 UE does not support this new 5GMM capability.

It is optional for the UE to support this ER-NSSAI mechanism, therefore the UE may not support the new ER-NSSAI, and the network may not be able to inform the UE about the back-off timer to indicate when the rejected NSSAI can be used.

Additionally, the network must have good analytics to estimate the back-off timer correctly, otherwise, it may result in new registration attempts by the UE where the UE may again be denied registration with the one or more S-NSSAIs with new back-off timers. This may also cause extra, unnecessary signaling due to registration procedure. For example, the network may lack the analytics to estimate the availability times for the rejected one or more S-NSSAIs due to being exhausted by many UEs are using them, and to then communicate those times with the UE via the new ER-NSSAI.

### Embodiment #1

According to embodiments of a first solution, the network may trigger the UE for a new registration with one or more S-NSSAIs, if the network has rejected the UE those one or more S-NSSAIs in an earlier registration and if one or some of the one or more S-NSSAIs are not congested.

### [FIG. 6—Registration Procedure]

FIG. 6 shows one example of a procedure 600 for registration, according to embodiments of the disclosure. The procedure 600 involves a UE 601, an Access Network (“AN”) 603, an AMF 605, a SMF 607, and a UPF 609. The UE 601 may be one implementation of the remote unit 105 and/or the UE 205. The AN 603 may be one implementation of the RAN 120 comprising a base unit 121 and/or the RAN node 210. The AMF 605 may be one implementation of the AMF 143 and/or AMF 215. The SMF 607 may be one implementation of the SMF 145. The UPF 609 may be one implementation of the UPF 141. A detailed description of the steps of the procedure 600 is as follows:

At Step 1, the UE 601 attempts to register with one or more S-NSSAI to the 5GC (see block 611). Here, it is assumed that the UE 601 does not support the ER-NSSAI and therefore may set ER-NSSAI to “0” (or does not include the ER-NSSAI IE at all) in the 5GMM capability IE of the REGISTRATION REQUEST message sent to the AMF 605 via the AN 603. Note that the registration to the 5GC may be based on 3GPP RAN or non-3GPP access technology.

At least one of the one or more S-NSSAIs are subject to NSAC and the maximum number of UEs has been reached. Therefore, the network (e.g., the AMF 605, or together with a Network Slice Selection Function (“NSSF”) and/or NSACF) determines which of the requested S-NSSAIs and the subscribed S-NSSAIs can be used by the UE 601.

If the UE supports ER-NSSAI, then the AMF 605 may send a registration accept message to accept the UE's registration and includes a Rejected NSSAI IE comprising those one or more S-NSSAIs for which the maximum number of UEs is reached. Note that the registration accept message may also include an Allowed NSSAI IE to indicate a network slice (S-NSSAI) that is not subject to NSAC or for which the maximum number of UEs is not reached. The Rejected NSSAI IE and the Allowed NSSAI IE each comprise a list of one or more S-NSSAI for which UE registration is rejected or allowed, respectively.

However, in the depicted embodiment the network does not use the ER-NSSAI IE, because the UE 601 did not include the ER-NSSAI capability IE or the ER-NSSAI bit is set to “1” and/or the network does not have a good analytics to estimate the back-off timer for the one or more rejected congested S-NSSAIs and therefore may not choose to use ER-NSSAI IE. For example, if the network lacks the analytics to estimate the availability times for the rejected one or more S-NSSAIs due to being exhausted by many UEs are using them, and to then communicate those times with the UE 601 via the new ER-NSSAI, then the network (e.g., AMF 605) may choose not to use the ER-NSSAI when registration to a S-NSSAI is rejected due to congestion/exhaustion of the network slice. With other words, the ER-NSSAI is only a tool which is used by the network to indicate, to a respective UE, the availability time for one or more S-NSSAIs subject to NSAC.

If the UE 601 does not indicate support for ER-NSSAI and the maximum number of UEs has been reached, then the AMF 605 includes the rejected NSSAI containing the one or more S-NSSAIs for which the maximum number of UEs is reached and does not include these S-NSSAIs in the allowed NSSAI. Note that the registration accept message may also include an Allowed NSSAI IE to indicate a network slice (e.g., identified by S-NSSAI) that is not subject to NSAC or for which the maximum number of UEs is not reached.

Note that, based on network policies, the AMF 605 can indicate the S-NSSAI(s) for which the maximum number of UEs has been reached in the rejected NSSAI with rejection causes other than “S-NSSAI not available in the current PLMN or SNPN”. For example, the AMF 605 may set the cause value to indicate that the S-NSSAI is not available in the network or registration area.

In addition, based on the network policies, the AMF 605 may start a local implementation specific timer for the UE 601 per rejected S-NSSAI.

At Step 2, the AMF 605 may have stored a status that the particular one or more S-NSSAIs were rejected for the maximum number of UEs reached, and optionally a time stamp when it was rejected, in the UE mobility context. If one or more S-NSSAIs, which were subject to NSAC with the reached maximum number of UEs but now, to which maximum number of UEs is not reached, the network (e.g., AMF 605) may check if the UE 601 was denied access to the one or more of these S-NSSAIs. The network (e.g., AMF 605) may also verify if the one or more S-NSSAIs are allowable, e.g., whether the one or more S-NSSAI can be used by the UE 601 in the current location and current AMF 605, by checking the UE's subscription information and stored mobility context.

If the one or more S-NSSAI subject to NSAC is available again (e.g., if the current number of registered UEs is lower than the maximum number of UEs), and there are multiple UEs to which the one of more S-NSSAI was rejected for the maximum number of UEs reached, the AMF 605 may assess: A) the time stamp of each stored status of the rejected S-NSSAI in the UEs contexts; and/or B) the subscription priority type of the UEs, and the AMF 605 may determine which UE(s) should be updated first.

At Step 3, the AMF 605 updates the UE 601 by performing a generic UE Configuration Update procedure (see block 615). Based on network policies, upon expiration of the local implementation specific timer, the AMF 605 may remove the rejected S-NSSAI from the rejected NSSAI and update to the UE 601 by initiating the generic UE Configuration Update procedure. In various embodiments, the UE 601 receives an indication that the previously rejected S-NSSAI (e.g., rejected for NSAC reasons) is excluded from the rejected NSSAI. Note that the generic UE Configuration Update procedure may or may not require the UE 601 to perform a (new) registration procedure.

In other words, the AMF 605 may transmit the new allowed NSSAI and/or the new rejected NSSAI (which does not contain the previously rejected one or more S-NSSAIs rejected for NSAC reasons) to the UE 601, e.g., by using the CONFIGURATION UPDATE COMMAND message. The AMF 605 may request for an acknowledgement which is transmitted by the UE 601, e.g., by a CONFIGURATION UPDATE COMPLETE message. In certain embodiments, where the rejected NSSAI consisted solely of the previously rejected S-NSSAI (e.g., rejected for NSAC reasons), then the AMF 605 may instruct the UE 601 to delete the complete rejected NSSAI. Note that the UE's rejected NSSAI can still exist with other S-NSSAIs.

At Step 4, the UE 601 initiates a mobility update registration (“MUR”) to request the network (e.g., AMF 605) to evaluate whether the one or more S-NSSAIs within the set of rejected NSSAI can be allowed by the network and if so, the UE 601 can use them (see block 617). In some embodiments, the S-NSSAI previously rejected for NSAC reasons does not get automatically allowed when the timer is expired. Here, the AMF 605 will not send an update message that the S-NSSAI which was rejected is now allowed. Rather, the AMF 605 just indicates to the UE 601 that S-NSSAI is not in the rejected NSSAI anymore (i.e., the S-NSSAI is not rejected any longer), therefore the UE 601 can let the network evaluate whether the S-NSSAI is allowed by performing MUR and including the S-NSSAI in the configured NSSAI. Once the network authenticated and authorized it, then the UE 601 receives that S-NSSAI in the allowed NSSAI.

At Step 4, the UE 601 is updated that it may use the one or more previously rejected S-NSSAI(s). The UE 601 may initiate a new registration procedure to include the one or more S-NSSAIs in the requested NSSAI. After a successful registration to the one or more S-NSSAIs, i.e., the one or more S-NSSAIs are included in the allowed S-NSSAI and/or excluded from the rejected NSSAI, the UE 601 may initiate a PDU session establishment procedure over the one or more S-NSSAIs (see block 619).

If the UE 601 has received an updated allowed NSSAI including the one or more S-NSSAIs and/or an updated rejected NSSAI including the one or more S-NSSAIs, the UE 601 can directly initiate the PDU session establishment procedure over the one or more S-NSSAIs (i.e., without a new registration procedure).

Note that the generic UE configuration update procedure may be over 3GPP RAN or non-3GPP access technology. Also, note that due to the nature of one or more S-NSSAI and/or UE's subscription information, the network may prioritize other UEs for assigning the one or more S-NSSAIs to and therefore the one or more S-NSSAIs may become part of rejected NSSAI for the maximum number of UEs reached for the UE 601. In that case, the network may use the same generic UE configuration update procedure to inform the UE 601 that the one or more S-NSSAIs are not in allowed NSSAI and/or they are in rejected NSSAI.

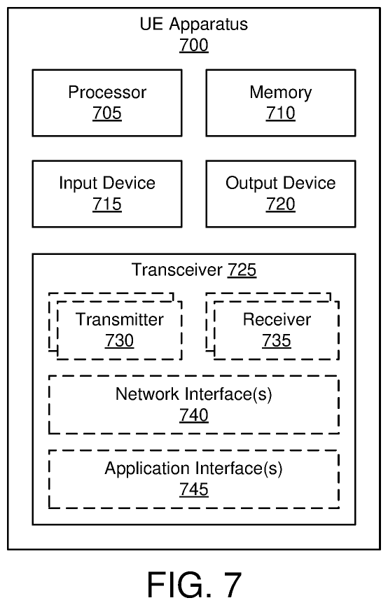

### [FIG. 7—UE Apparatus]

FIG. 7 depicts a UE apparatus 700 that may be used for registering to a congested network slice, according to embodiments of the disclosure. In various embodiments, the UE apparatus 700 is used to implement one or more of the solutions described above. The UE apparatus 700 may be one embodiment of a UE endpoint, such as the remote unit 105, the UE 205, and/or the UE 601, as described above. Furthermore, the UE apparatus 700 may include a processor 705, a memory 710, an input device 715, an output device 720, and a transceiver 725.

In some embodiments, the input device 715 and the output device 720 are combined into a single device, such as a touchscreen. In certain embodiments, the UE apparatus 700 may not include any input device 715 and/or output device 720. In various embodiments, the UE apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. In some embodiments, the transceiver 725 communicates with one or more cells (or wireless coverage areas) supported by one or more base units 121. In various embodiments, the transceiver 725 is operable on unlicensed spectrum. Moreover, the transceiver 725 may include multiple UE panels supporting one or more beams. Additionally, the transceiver 725 may support at least one network interface 740 and/or application interface 745. The application interface(s) 745 may support one or more APIs. The network interface(s) 740 may support 3GPP reference points, such as Uu, N1, PC5, etc. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725.

In various embodiments, the processor 705 controls the UE apparatus 700 to implement the above described UE behaviors. In certain embodiments, the processor 705 may include an application processor (also known as “main processor”) which manages application-domain and operating system (“OS”) functions and a baseband processor (also known as “baseband radio processor”) which manages radio functions.

### [Ue Behavior]

In various embodiments, via the transceiver 725, the processor 705 sends a registration request to register to a network slice (e.g., identified by S-NSSAI) in a mobile communication network, where the network slice subject to NSAC. Note that the solutions described herein do not require that the apparatus 700 be aware that the requested NSSAI is subject to NSAC.

In some embodiments, the processor is further configured to cause the apparatus to send, to the access management function (e.g., an AMF or MME), capability information (e.g., a 5GMM capability IE) including an indication that the communication device does not support ER-NSSAI (e.g., ER-NSSAI capability IE is set to ‘0’ or no ER-NSSAI capability IE sent). In certain embodiments, the registration request includes the indication that the communication device does not support ER-NSSAI.

Via the transceiver 725, the processor 705 receives, from an access management function (e.g., an AMF or MME), a first response including an allowed set of network slices and a first indication (e.g., rejected NSSAI) that rejects registration to the network slice. In some embodiments, the first response includes a rejected NSSAI that indicates/identifies the network slice and contains a non-NSAC-based rejection cause value, such as a cause value indicating that the S-NSSAI is not available in the network or registration area. Here, the rejected NSSAI contains S-NSSAI that corresponds to the network slice.

Via the transceiver 725, the processor 705 receives, from the access management function (e.g., an AMF or MME), a second response including an indication that the communication device is permitted to register to the network slice and establishes a data connection (e.g., a PDU session) using the network slice. In some embodiments, the second response is received during a UE configuration update procedure. In certain embodiments, the UE configuration update procedure requires new registration to the mobile communication network.

In some embodiments, to indicate that the communication device is permitted to register to the network slice (e.g., initiate MUR to request the network evaluate whether registration to the network slice can be allowed by the network), the update message contains updated rejected NSSAI that excludes (e.g., does not contain) the S-NSSAI corresponding to the network slice. In certain embodiments, to indicate that the communication device is permitted to register to the network slice, the second response (e.g., an update message) includes an indication that the rejected NSSAI is to be deleted (e.g., because the rejected NSSAI contained only the S-NSSAI of the network slice subject to NSAC).

The memory 710, in one embodiment, is a computer readable storage medium. In some embodiments, the memory 710 includes volatile computer storage media. For example, the memory 710 may include a RAM, including dynamic RAM (“DRAM”), synchronous dynamic RAM (“SDRAM”), and/or static RAM (“SRAM”). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to registering to a congested network slice. For example, the memory 710 may store various parameters, panel/beam configurations, resource assignments, policies, and the like as described above. In certain embodiments, the memory 710 also stores program code and related data, such as an operating system or other controller algorithms operating on the UE apparatus 700.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 720 may include a wearable display separate from, but communicatively coupled to, the rest of the UE apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, the output device 720 may be located near the input device 715.

The transceiver 725 communicates with one or more NFs of a mobile communication network via one or more access networks. The transceiver 725 operates under the control of the processor 705 to transmit messages, data, and other signals and also to receive messages, data, and other signals. For example, the processor 705 may selectively activate the transceiver 725 (or portions thereof) at particular times in order to send and receive messages.

The transceiver 725 includes at least transmitter 730 and at least one receiver 735. One or more transmitters 730 may be used to provide UL communication signals to a base unit 121, such as the UL transmissions described herein. Similarly, one or more receivers 735 may be used to receive DL communication signals from the base unit 121, as described herein. Although only one transmitter 730 and one receiver 735 are illustrated, the UE apparatus 700 may have any suitable number of transmitters 730 and receivers 735. Further, the transmitter(s) 730 and the receiver(s) 735 may be any suitable type of transmitters and receivers. In one embodiment, the transceiver 725 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 725, transmitters 730, and receivers 735 may be implemented as physically separate components that access a shared hardware resource and/or software resource, such as for example, the network interface 740.

In various embodiments, one or more transmitters 730 and/or one or more receivers 735 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 730 and/or one or more receivers 735 may be implemented and/or integrated into a multi-chip module. In some embodiments, other components such as the network interface 740 or other hardware components/circuits may be integrated with any number of transmitters 730 and/or receivers 735 into a single chip. In such embodiment, the transmitters 730 and receivers 735 may be logically configured as a transceiver 725 that uses one more common control signals or as modular transmitters 730 and receivers 735 implemented in the same hardware chip or in a multi-chip module.

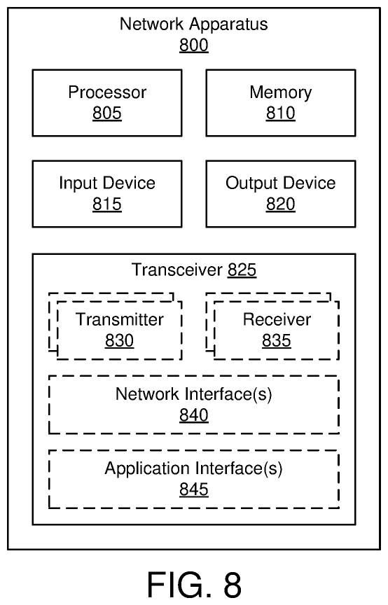

### [FIG. 8—Nw/Ran Apparatus]

FIG. 8 depicts a network apparatus 800 that may be used for registering to a congested network slice, according to embodiments of the disclosure. In one embodiment, network apparatus 800 may be one implementation of a network endpoint, such as the base unit 121 and/or RAN node 207, as described above. Furthermore, the network apparatus 800 may include a processor 805, a memory 810, an input device 815, an output device 820, and a transceiver 825.

In some embodiments, the input device 815 and the output device 820 are combined into a single device, such as a touchscreen. In certain embodiments, the network apparatus 800 may not include any input device 815 and/or output device 820. In various embodiments, the network apparatus 800 may include one or more of: the processor 805, the memory 810, and the transceiver 825, and may not include the input device 815 and/or the output device 820.

As depicted, the transceiver 825 includes at least one transmitter 830 and at least one receiver 835. Here, the transceiver 825 communicates with one or more remote units 105. Additionally, the transceiver 825 may support at least one network interface 840 and/or application interface 845. The application interface(s) 845 may support one or more APIs. The network interface(s) 840 may support 3GPP reference points, such as Uu, N1, N2 and N3. Other network interfaces 840 may be supported, as understood by one of ordinary skill in the art.

The processor 805, in one embodiment, may include any known controller capable of executing computer-readable instructions and/or capable of performing logical operations. For example, the processor 805 may be a microcontroller, a microprocessor, a CPU, a GPU, an auxiliary processing unit, a FPGA, or similar programmable controller. In some embodiments, the processor 805 executes instructions stored in the memory 810 to perform the methods and routines described herein. The processor 805 is communicatively coupled to the memory 810, the input device 815, the output device 820, and the transceiver 825.

In various embodiments, the network apparatus 800 is a RAN node (e.g., gNB) that communicates with one or more UEs, as described herein. In such embodiments, the processor 805 controls the network apparatus 800 to perform the above described RAN behaviors. In some embodiments, the network apparatus 800 may configure one or more endpoint devices with the Training Sequences to be used in the key verification procedure. When operating as a RAN node, the processor 805 may include an application processor (also known as “main processor”) which manages application-domain and OS functions and a baseband processor (also known as “baseband radio processor”) which manages radio functions.

### [Amf Behavior]

In various embodiments, via the transceiver 825, the processor 805 receives a registration request from the communication device to register to a network slice (e.g., identified by S-NSSAI) subject to NSAC. Note that the solutions described herein do not require that the communication device (e.g., a UE) be aware that the requested S-NSSAI is subject to NSAC.

The processor 805 determines that registration to the network slice is rejected for NSAC (e.g., because a maximum number of UEs is reached). In some embodiments, to determine that the registration to the network slice is rejected, the processor 805 receives (e.g., via the transceiver 825) an indication from a NF (e.g., NSSF or NSACF) that a limit is reached for a network slice attribute for the network slice subject to NSAC. For example, a maximum number of registered UEs per network slice may be reached for a particular S-NSSAI requested by the communication device. As used herein, an “indication” could be an explicit indication-such as an error code, flag, parameter, IE, etc.—or could be an implicit indication—e.g., inferred from a message type, a sender/receiver, the absence of another indication/parameter, etc.

In some embodiments, the processor 805 sends (e.g., via the transceiver 825) rejected NSSAI to the communication device in response to determining that the registration to the network slice is rejected. In such embodiments, the rejected NSSAI indicates/identifies the network slice and contains a non-NSAC-based rejection cause value, such as a cause value indicating that the S-NSSAI is not available in the network or registration area.

The processor 805 initiates a timer in response to determining that the registration to the network slice is rejected. In some embodiments, the processor 805 determines that the network apparatus 800 lacks analytics information to support ER-NSSAI. In such embodiments, the processor 805 initiates the timer in response to determining that the network apparatus 800 lacks analytics information to support ER-NSSAI.

In other embodiments, the processor 805 determines that the communication device does not support ER-NSSAI and initiates the timer in response to determining that the communication device does not support ER-NSSAI. In certain embodiments, to determine that the communication device does not support ER-NSSAI, the processor 805 receives (e.g., via the transceiver 825) capability information that includes an indication that the communication device does not support ER-NSSAI. For example, the transceiver 825 may receive, from the communication device, a 5GMM capability IE that either contains an ER-NSSAI capability IE is set to ‘0’ or does not contain any ER-NSSAI capability IE.

Via the transceiver 825, the processor 805 sends, to the communication device, an update message in response to expiry of the timer, the update message containing an indication that the communication device is permitted to register to the network slice. In some embodiments, to send the update message, the processor 805 initiates a UE configuration update procedure.

In some embodiments, to indicate that the communication device is permitted to register to the network slice (e.g., signal that the communication device may initiate MUR to request the network evaluate whether registration to the network slice can be allowed by the network), the update message contains updated rejected NSSAI that excludes (e.g., does not contain) the S-NSSAI corresponding to the network slice. In certain embodiments, to indicate that the communication device is permitted to register to the network slice, the update message contains an indication that the rejected NSSAI is to be deleted (e.g., because the rejected NSSAI contained only the S-NSSAI of the network slice subject to NSAC).

In certain embodiments, the processor 805 maps a NSAC-based rejection cause value to a non-NSAC-based rejection cause value in response to determining that the communication device does not support ER-NSSAI and, via the transceiver 825, sends rejected NSSAI to the communication device. In such embodiments, the rejected NSSAI indicates the network slice and contains the non-NSAC-based rejection cause value. Here, the rejected NSSAI contains S-NSSAI that corresponds to the network slice.

In some embodiments, the processor 805 stores, for the communication device, context information containing rejected NSSAI which indicates that the network slice was rejected for NSAC. Additionally, the processor 805 determines whether the network slice is again available (e.g., because the NSAC limit is no longer met). In response to determining that the network slice is again available, the processor sends the update message.

The memory 810, in one embodiment, is a computer readable storage medium. In some embodiments, the memory 810 includes volatile computer storage media. For example, the memory 810 may include a RAM, including DRAM, SDRAM, and/or SRAM. In some embodiments, the memory 810 includes non-volatile computer storage media. For example, the memory 810 may include a hard disk drive, a flash memory, or any other suitable non-volatile computer storage device. In some embodiments, the memory 810 includes both volatile and non-volatile computer storage media.

In some embodiments, the memory 810 stores data related to registering to a congested network slice. For example, the memory 810 may store parameters, configurations, resource assignments, policies, and the like, as described above. In certain embodiments, the memory 810 also stores program code and related data, such as an operating system or other controller algorithms operating on the network apparatus 800.

The input device 815, in one embodiment, may include any known computer input device including a touch panel, a button, a keyboard, a stylus, a microphone, or the like. In some embodiments, the input device 815 may be integrated with the output device 820, for example, as a touchscreen or similar touch-sensitive display. In some embodiments, the input device 815 includes a touchscreen such that text may be input using a virtual keyboard displayed on the touchscreen and/or by handwriting on the touchscreen. In some embodiments, the input device 815 includes two or more different devices, such as a keyboard and a touch panel.

The output device 820, in one embodiment, is designed to output visual, audible, and/or haptic signals. In some embodiments, the output device 820 includes an electronically controllable display or display device capable of outputting visual data to a user. For example, the output device 820 may include, but is not limited to, an LCD display, an LED display, an OLED display, a projector, or similar display device capable of outputting images, text, or the like to a user. As another, non-limiting, example, the output device 820 may include a wearable display separate from, but communicatively coupled to, the rest of the network apparatus 800, such as a smart watch, smart glasses, a heads-up display, or the like. Further, the output device 820 may be a component of a smart phone, a personal digital assistant, a television, a table computer, a notebook (laptop) computer, a personal computer, a vehicle dashboard, or the like.

In certain embodiments, the output device 820 includes one or more speakers for producing sound. For example, the output device 820 may produce an audible alert or notification (e.g., a beep or chime). In some embodiments, the output device 820 includes one or more haptic devices for producing vibrations, motion, or other haptic feedback. In some embodiments, all or portions of the output device 820 may be integrated with the input device 815. For example, the input device 815 and output device 820 may form a touchscreen or similar touch-sensitive display. In other embodiments, the output device 820 may be located near the input device 815.

The transceiver 825 includes at least transmitter 830 and at least one receiver 835. One or more transmitters 830 may be used to communicate with the UE, as described herein. Similarly, one or more receivers 835 may be used to communicate with NFs in the PLMN and/or RAN, as described herein. Although only one transmitter 830 and one receiver 835 are illustrated, the network apparatus 800 may have any suitable number of transmitters 830 and receivers 835. Further, the transmitter(s) 830 and the receiver(s) 835 may be any suitable type of transmitters and receivers.

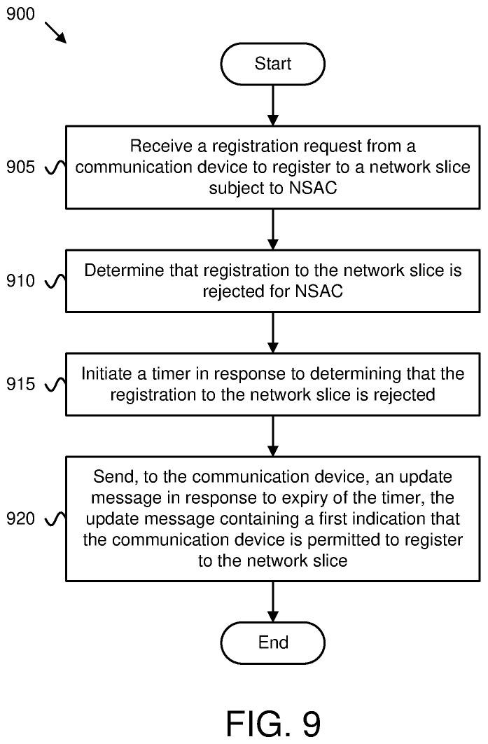

### [FIG. 9—AMF Method]

FIG. 9 depicts one embodiment of a method 900 for registering to a congested network slice, according to embodiments of the disclosure. In various embodiments, the method 900 is performed by a network device, such as the AMF 143, the AMF 215, the AMF 605, and/or the network apparatus 800, as described above. In some embodiments, the method 900 is performed by a processor, such as a microcontroller, a microprocessor, a CPU, a GPU, an auxiliary processing unit, a FPGA, or the like.

The method 900 includes receiving 905 a registration request from a communication device (e.g., a UE) to register to a network slice (i.e., identified by S-NSSAI) subject to NSAC. The method 900 includes determining 910 that registration to the network slice is rejected for NSAC (e.g., because a maximum number of UEs is reached). The method 900 includes initiating 915 a timer in response to determining that the registration to the network slice is rejected. The method 900 includes sending 920, to the communication device, an update message in response to expiry of the timer, the update message containing an indication that the communication device is permitted to register to the network slice. The method 900 ends.

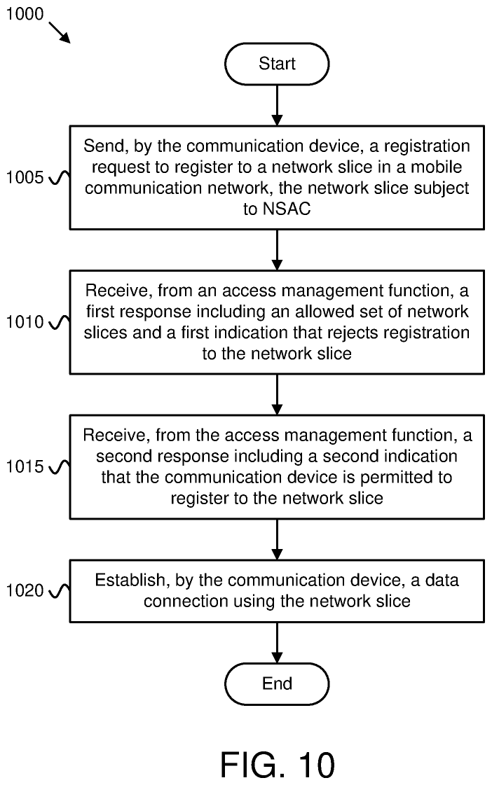

### [FIG. 10—UE Method]

FIG. 10 depicts one embodiment of a method 1000 for registering to a congested network slice, according to embodiments of the disclosure. In various embodiments, the method 1000 is performed by a communication device, such as the remote unit 105, the UE 205, the UE 601, and/or the UE apparatus 700, described above, as described above. In some embodiments, the method 1000 is performed by a processor, such as a microcontroller, a microprocessor, a CPU, a GPU, an auxiliary processing unit, a FPGA, or the like.

The method 1000 includes sending 1005, by the communication device, a registration request to register to a network slice (e.g., identified by S-NSSAI) in a mobile communication network, the network slice subject to NSAC. The method 1000 includes receiving 1010, from an access management function (e.g., an AMF or MME), a first response including an allowed set of network slices and a first indication (e.g., rejected NSSAI) that rejects registration to the network slice. The method 1000 includes receiving 1015, from the access management function, a second response including a second indication that the communication device is permitted to register to the network slice. The method 1000 includes establishing 1020, by the communication device, a data connection (e.g., a PDU session) using the network slice. The method 1000 ends.

### [Claim Statements]

### [AMF Apparatus]

Disclosed herein is a first apparatus for registering to a congested network slice, according to embodiments of the disclosure. The first apparatus may be implemented by a network device, such as the AMF 143, the AMF 215, the AMF 605, and/or the network apparatus 800, described above. The first apparatus includes a processor coupled to a transceiver, the transceiver configured to communicate with a communication device (e.g., a UE) and the processor configured to cause the apparatus to: A) receive a registration request from the communication device to register to a network slice (e.g., identified by S-NSSAI) subject to NSAC: B) determine that a registration to the network slice is rejected for NSAC (e.g., because a maximum number of UEs is reached): C) initiate a timer in response to the registration to the network slice being rejected; and D) send, to the communication device, an update message in response to expiry of the timer, the update message including a first indication that the communication device is permitted to register to the network slice.

In some embodiments, the processor is further configured to cause the apparatus to determine that the communication device does not support ER-NSSAI. In such embodiments, the processor is configured to cause the apparatus to initiate the timer in response to determining that the communication device does not support ER-NSSAI. In certain embodiments, to determine that the communication device does not support ER-NSSAI, the processor is configured to cause the apparatus to receive capability information (e.g., a 5GMM capability IE) including a second indication that the communication device does not support ER-NSSAI (e.g., ER-NSSAI capability IE is set to ‘0’ or no ER-NSSAI capability IE sent).

In certain embodiments, the processor is further configured to cause the apparatus to: A) map a NSAC-based rejection cause value to a non-NSAC-based rejection cause value in response to determining that the communication device does not support ER-NSSAI; and B) send rejected NSSAI to the communication device, where the rejected NSSAI indicates the network slice and includes the non-NSAC-based rejection cause value.

In some embodiments, the processor is further configured to cause the apparatus to determine that the first apparatus lacks analytics information to support ER-NSSAI. In such embodiments, the processor is configured to cause the apparatus to initiate the timer in response to determining that the first apparatus lacks analytics information to support ER-NSSAI.

In some embodiments, to determine that the registration to the network slice is rejected, the processor is configured to cause the apparatus to receive an indication from a NF (e.g., NSSF or NSACF) that a maximum number of registered users is reached for the network slice.

In some embodiments, the processor is further configured to cause the apparatus to send rejected NSSAI to the communication device. In such embodiments, the rejected NSSAI indicates the network slice and includes a non-NSAC-based rejection cause value. Here, the rejected NSSAI contains S-NSSAI that corresponds to the network slice. In further embodiments, to indicate that the communication device is permitted to register to the network slice, the update message contains updated rejected NSSAI that excludes (e.g., does not contain) the S-NSSAI corresponding to the network slice. In certain embodiments, to indicate that the communication device is permitted to register to the network slice, the update message includes an indication that the rejected NSSAI is to be deleted (e.g., because the rejected NSSAI contained only the S-NSSAI of the network slice subject to NSAC).

In some embodiments, the processor is further configured to cause the apparatus to: A) store, for the communication device, mobility context information including rejected NSSAI which indicates that the network slice was rejected for NSAC; and B) determine that the network slice is again available (e.g., because the NSAC limit is no longer met). In such embodiments, the processor is configured to cause the apparatus to send the update message in response to determining that the network slice is again available. In some embodiments, to send the update message, the processor is configured to cause the apparatus to initiate a UE configuration update procedure.

### [AMF Method]

Disclosed herein is a first method for registering to a congested network slice, according to embodiments of the disclosure. The first method may be performed by a network device, such as the AMF 143, the AMF 215, the AMF 605, and/or the network apparatus 800, described above. The first method includes receiving a registration request from a communication device (e.g., a UE) to register to a network slice (i.e., identified by S-NSSAI) subject to NSAC and determining that registration to the network slice is rejected for NSAC (e.g., because a maximum number of UEs is reached). The first method includes initiating a timer in response to determining that the registration to the network slice is rejected and sending, to the communication device, an update message in response to expiry of the timer, the update message including an indication that the communication device is permitted to register to the network slice.

In some embodiments, the first method includes determining that the communication device does not support ER-NSSAI. In such embodiments, initiating the timer occurs in response to determining that the communication device does not support ER-NSSAI. When determining that the communication device does not support ER-NSSAI, the first method may include receiving capability information (e.g., a 5GMM capability IE) including an indication that the communication device does not support ER-NSSAI (e.g., ER-NSSAI capability IE is set to ‘0’ or no ER-NSSAI capability IE sent).

In certain embodiments, in response to determining that the communication device does not support ER-NSSAI, the first method may include mapping a NSAC-based rejection cause value to a non-NSAC-based rejection cause value and sending rejected NSSAI to the communication device, where the rejected NSSAI indicates the network slice and includes the non-NSAC-based rejection cause value.

In some embodiments, the first method includes determining that the access management function lacks analytics information to support ER-NSSAI. In such embodiments, initiating the timer occurs in response to determining that the access management function lacks analytics information to support ER-NSSAI. In some embodiments, determining that the registration to the network slice is rejected includes the network device (e.g., an access management function) receiving an indication from a NF (e.g., NSSF or NSACF) that a maximum number of registered users is reached for the network slice.

In some embodiments, the first method further includes sending rejected NSSAI to the communication device. In such embodiments, the rejected NSSAI indicates the network slice and includes a non-NSAC-based rejection cause value. Here, the rejected NSSAI contains S-NSSAI that corresponds to the network slice. In further embodiments, to indicate that the communication device is permitted to register to the network slice, the update message contains updated rejected NSSAI that excludes (e.g., does not contain) the S-NSSAI corresponding to the network slice. In some embodiments, to indicate that the communication device is permitted to register to the network slice, the update message may include an indication that the rejected NSSAI is to be deleted (e.g., because the rejected NSSAI contained only the S-NSSAI of the network slice subject to NSAC).

In some embodiments, the first method further includes storing, for the communication device, mobility context information including rejected NSSAI which indicates that the network slice was rejected for NSAC and determining whether the network slice is again available. In such embodiments, sending the update message further occurs in response to determining that the network slice is again available (e.g., the NSAC limit is underrun). In some embodiments, sending the update message includes initiating a UE configuration update procedure.

### [Ue Apparatus]

Disclosed herein is a second apparatus for registering to a congested network slice, according to embodiments of the disclosure. The second apparatus may be implemented by a communication device, such as the remote unit 105, the UE 205, the UE 601, and/or the UE apparatus 700, described above. The second apparatus includes a processor coupled to a transceiver, the transceiver configured to communicate with a mobile communication network and the processor configured to cause the apparatus to: A) send a registration request to register to a network slice (e.g., identified by S-NSSAI) in a mobile communication network, the network slice subject to NSAC: B) receive, from an access management function (e.g., an AMF or MME), a first response including an allowed set of network slices and an indication (e.g., rejected NSSAI) that rejects registration to the network slice: C) receive, from the access management function, a second response including an indication that the communication device is permitted to register to the network slice; and D) establish a data connection (e.g., a PDU session) using the network slice.

In some embodiments, the second response is received during a UE configuration update procedure. In certain embodiments, the UE configuration update procedure requires new registration to the mobile communication network. In some embodiments, the processor is further configured to cause the apparatus to send, to the access management function, capability information (e.g., a 5GMM capability IE) including an indication that the communication device does not support ER-NSSAI (e.g., ER-NSSAI capability IE is set to ‘0’ or no ER-NSSAI capability IE sent). In certain embodiments, the registration request includes the indication that the communication device does not support ER-NSSAI.

In some embodiments, the first response includes a rejected NSSAI that indicates the network slice and includes a non-NSAC-based rejection cause value. Here, the rejected NSSAI contains S-NSSAI that corresponds to the network slice. In some embodiments, to indicate that the communication device is permitted to register to the network slice, the update message contains updated rejected NSSAI that excludes (e.g., does not contain) the S-NSSAI corresponding to the network slice. In certain embodiments, to indicate that the communication device is permitted to register to the network slice, the second response (e.g., an update message) includes an indication that the rejected NSSAI is to be deleted (e.g., because the rejected NSSAI contained only the S-NSSAI of the network slice subject to NSAC).

### [UE Method]

Disclosed herein is a second method for registering to a congested network slice, according to embodiments of the disclosure. The second method may be performed by a communication device, such as the remote unit 105, the UE 205, the UE 601, and/or the UE apparatus 700, described above. The second method includes sending, by the communication device, a registration request to register to a network slice (e.g., identified by S-NSSAI) in a mobile communication network, the network slice subject to NSAC and receiving, from an access management function (e.g., an AMF or MME), a first response including an allowed set of network slices and an indication (e.g., rejected NSSAI) that rejects registration to the network slice. The second method includes receiving, from the access management function, a second response including an indication that the communication device is permitted to register to the network slice and establishing, by the communication device, a data connection (e.g., a PDU session) using the network slice.

In some embodiments, the second response is received during a UE configuration update procedure, where the UE configuration update procedure requires new registration to the mobile communication network. In some embodiments, the second method further including sending, to the access management function, capability information (e.g., a 5GMM capability IE) including an indication that the communication device does not support ER-NSSAI (e.g., ER-NSSAI capability IE is set to ‘0’ or no ER-NSSAI capability IE sent). In certain embodiments, the registration request includes the indication that the communication device does not support ER-NSSAI.

In some embodiments, the first response includes a rejected NSSAI that indicates the network slice and includes a non-NSAC-based rejection cause value. Here, the rejected NSSAI contains S-NSSAI that corresponds to the network slice. In some embodiments, to indicate that the communication device is permitted to register to the network slice, the update message contains updated rejected NSSAI that excludes (e.g., does not contain) the S-NSSAI corresponding to the network slice. In certain embodiments, to indicate that the communication device is permitted to register to the network slice, the second response (e.g., an update message) includes an indication that the rejected NSSAI is to be deleted (e.g., because the rejected NSSAI contained only the S-NSSAI of the network slice subject to NSAC).

Embodiments may be practiced in other specific forms. The described embodiments are to be considered in all respects only as illustrative and not restrictive. The scope of the invention is, therefore, indicated by the appended claims rather than by the foregoing 5 description. All changes which come within the meaning and range of equivalency of the claims are to be embraced within their scope.

1. An apparatus comprising:
a transceiver; and
a processor coupled to the transceiver, the processor configured to cause the apparatus to:
receive a registration request from a device to register to a network slice subject to network slice admission control (“NSAC”);
determine that a registration to the network slice is rejected for NSAC;
initiate a timer in response to the registration to the network slice being rejected; and
send, to the device, an update message in response to expiry of the timer, the update message comprising a first indication that the device is permitted to register to the network slice.

2. The apparatus of claim 1, wherein the processor is further configured to cause the apparatus to determine that the device does not support extended rejected network slice selection assistance information (“ER-NSSAI”), wherein the processor is configured to cause the apparatus to initiate the timer in response to determining that the device does not support ER-NSSAI.

3. The apparatus of claim 2, wherein the processor is further configured to cause the apparatus to:
map a NSAC-based rejection cause value to a non-NSAC-based rejection cause value in response to determining that the device does not support ER-NSSAI; and
send rejected network slice selection assistance information (“NSSAI”) to the device, wherein the rejected NSSAI indicates the network slice and comprises the non-NSAC-based rejection cause value.

4. The apparatus of claim 2, wherein, to determine that the device does not support ER-NSSAI, the processor is configured to cause the apparatus to receive capability information comprising a second indication that the device does not support ER-NSSAI.

5. The apparatus of claim 1, wherein the processor is further configured to cause the apparatus to determine that the apparatus lacks analytics information to support extended rejected network slice selection assistance information (“ER-NSSAI”), wherein the processor is configured to cause the apparatus to initiate the timer in response to determining that the apparatus lacks analytics information to support ER-NSSAI.

6. The apparatus of claim 1, wherein, to determine that the registration to the network slice is rejected, the processor is configured to cause the apparatus to receive a second indication from a network function that a maximum number of registered users is reached for the network slice.

7. The apparatus of claim 1, wherein the processor is further configured to cause the apparatus to:
send rejected network slice selection assistance information (“NSSAI”) to the device, wherein the rejected NSSAI indicates the network slice and comprises a non-NSAC-based rejection cause value,
wherein, to indicate that the device is permitted to register to the network slice, the first indication comprises a respective indication that the rejected NSSAI is to be deleted.

8. The apparatus of claim 1, wherein the processor is further configured to cause the apparatus to:
store, for the device, mobility context information comprising rejected network slice selection assistance information (“NSSAI”) which indicates that the network slice was rejected for NSAC; and
determine whether the network slice is again available,
wherein the processor is configured to cause the apparatus to send the update message in response to determining that the network slice is again available.

9. The apparatus of claim 1, wherein the processor is further configured to cause the apparatus to:
send a rejected network slice selection assistance information (“NSSAI”) to the device, wherein the rejected NSSAI contains single network slice selection assistance information (“S-NSSAI”) that corresponds to the network slice,
wherein, to send the update message, the processor is configured to cause the apparatus to initiate a User Equipment (“UE”) configuration update procedure,
wherein, to indicate that the device is permitted to register to the network slice, the update message comprises updated rejected network slice selection assistance information (“NSSAI”) that excludes the S-NSSAI corresponding to the network slice.

10. A method of an access management function, the method comprising:
receiving a registration request from a device to register to a network slice subject to network slice admission control (“NSAC”);
determining that registration to the network slice is rejected for NSAC;
initiating a timer in response to determining that the registration to the network slice is rejected; and
sending, to the device, an update message in response to expiry of the timer, the update message comprising a first indication that the device is permitted to register to the network slice.

11. A User Equipment (“UE”) apparatus comprising:
a transceiver configured to communicate with a mobile communication network;
a processor coupled to the transceiver, the processor configured to:
send, by a device, a registration request to register to a network slice in a mobile communication network, the network slice subject to network slice admission control (“NSAC”);
receive, from an access management function, a first response comprising an allowed set of network slices and a first indication that rejects registration to the network slice;
receive, from the access management function, a second response comprising a second indication that the device is permitted to register to the network slice; and
establish, by the device, a data connection using the network slice.

12. The apparatus of claim 11, wherein the second response is received during a User Equipment (“UE”) configuration update procedure, wherein the UE configuration update procedure requires new registration to the mobile communication network.

13. The apparatus of claim 11,
wherein the first response comprises rejected network slice selection assistance information (“NSSAI”) that indicates the network slice,
wherein, to indicate that the device is permitted to register to the network slice, the second response comprises updated rejected network slice selection assistance information (“NSSAI”) that excludes the S-NSSAI corresponding to the network slice.

14. The apparatus of claim 11, wherein the processor is further configured to cause the apparatus to send, to the access management function, capability information comprising a second indication that the device does not support extended rejected network slice selection assistance information (“ER-NSSAI”).

15. The apparatus of claim 11,
wherein the first response comprises rejected network slice selection assistance information (“NSSAI”) that indicates the network slice and comprises a non-NSAC-based rejection cause value, and
wherein, to indicate that the device is permitted to register to the network slice, the second indication comprises a respective indication that the rejected NSSAI is to be deleted.
